(19) United States
(12) Patent Application Publication
(10) Pub. No.: US 2025/0385976 A1
(43) Pub. Date: Dec. 18, 2025

(54) IMAGE PROCESSING APPARATUS AND OPERATION KEY DISPLAY METHOD

(71) Applicant: SHARP KABUSHIKI KAISHA, Osaka (JP)

(72) Inventor: KAZUHISA KUBOTA, Osaka (JP)

(21) Appl. No.: 19/218,856

(22) Filed: May 27, 2025

(30) Foreign Application Priority Data
Jun. 13, 2024 (JP) 2024-095636

(51) Int. Cl. H04N 1/00; G06F 3/04842

(52) U.S. Cl. CPC H04N 1/00482; G06F 3/04842; H04N 1/00411; H04N 1/00432

(57) ABSTRACT

An image processing apparatus includes a display that displays, on an operation screen, operation keys associated with functions related to image processing and receiving an instruction to select a function to be used; one or more controllers that control displaying the operation key on the operation screen; and a register that registers the function with restriction on use, the operation screen includes a first display region capable of displaying the operation key and a second display region different from the first display region, and the one or more controllers control displaying the operation key in the first display region and the second display region with respect to the function registered in the register.

### FIELD OF THE INVENTION

The present disclosure relates to an image processing apparatus and the like.

### BACKGROUND ART

An image processing apparatus such as a multifunction apparatus displays an operation screen that receives operation instructions from a user on a display device. In the operation screen, a variable region in which display content can be changed based on an operation instruction from the user, and a fixed region in which display content remains unchanged before and after the display content in the variable region is changed may be provided as a plurality of display regions.

In particular, an operation screen that has an operation key (shortcut key) that receives an instruction to select a function used in an image processing apparatus, such as a copy function, a fax function, and an e-mail function, and has, in a variable region, a screen configuration that is a starting point for a screen transition to an operation screen of each function, is generally called a home screen and is displayed on a display device, for example, at a timing such as at the time of power-on of the image processing apparatus, standby, or recovery from a sleep state.

### SUMMARY

### Technical Problem

An object of the present disclosure is to provide, for example, an image processing apparatus capable of improving the operability related to function selection for a user in an image processing apparatus that receives an instruction to select a function to be used, via an operation screen including a plurality of display regions.

### Solution to Problem

In order to solve the problem, an image processing apparatus according to the present disclosure includes a display that displays, on an operation screen, operation keys associated with functions related to image processing and receiving an instruction to select a function to be used; a controller that controls displaying the operation key on the operation screen; and a register that registers the function with restriction on use, wherein the operation screen includes a first display region capable of displaying the operation key and a second display region different from the first display region, and the controller controls displaying the operation key in the first display region and the second display region with respect to the function registered in the register.

Further, an image processing apparatus according to the present disclosure includes: a display that displays, on an operation screen, operation keys associated with functions related to image processing and receiving an instruction to select a function to be used; and a controller that controls displaying the operation key on the operation screen, wherein the operation screen includes a first display region capable of displaying the operation key and a second display region different from the first display region, and the controller restricts displaying the operation key corresponding to the function in the second display region when an operation screen based on a function corresponding to the operation key is displayed on the display, according to the instruction to select the operation key displayed on at least one of the first display region and the second display region.

Further, an operation key display method according to the present disclosure is an operation key display method for displaying, on an operation screen, operation keys associated with functions related to image processing and receiving an instruction to select a function to be used, wherein the operation screen includes a first display region capable of displaying the operation key and a second display region different from the first display region, and the operation key display method includes registering the function with restriction on use; and controlling displaying the operation key in the first display region and the second display region with respect to the registered function.

### Advantageous Effects of Disclosure

According to the present disclosure, it is possible to provide, for example, an image processing apparatus capable of improving the operability of function selection for a user in an image processing apparatus that receives an instruction to select a function to be used, via an operation screen including a plurality of display regions.

### BRIEF DESCRIPTION OF THE DRAWINGS

FIG. 1 is a diagram illustrating an overall configuration of a multifunction apparatus according to a first embodiment.

FIG. 2 is a diagram illustrating a functional configuration of the multifunction apparatus according to the first embodiment.

FIGS. 3A and 3B are a diagram illustrating a registration-prohibited function table.

FIG. 4 is a flowchart illustrating a processing flow according to the first embodiment.

FIG. 5 is a flowchart illustrating a processing flow according to the first embodiment.

FIG. 6 is a diagram illustrating an operation example according to the first embodiment.

FIGS. 7A and 7B are a diagram illustrating an operation example according to the first embodiment.

FIG. 8 is a diagram illustrating an operation example according to the first embodiment.

FIG. 9 is a diagram illustrating an operation example according to the first embodiment.

FIG. 10 is a diagram illustrating an operation example according to the first embodiment.

FIG. 11 is a diagram illustrating an operation example according to the first embodiment.

FIG. 12 is a diagram illustrating a use count management table.

FIG. 13 is a diagram illustrating an operation example according to a second embodiment.

FIG. 14 is a diagram illustrating a functional configuration of a multifunction apparatus according to a third embodiment.

FIG. 15 is a flowchart illustrating a processing flow according to the third embodiment.

FIG. 16 is a diagram illustrating an operation example according to the third embodiment.

FIG. 17 is a diagram illustrating an example of a screen configuration of a home screen.

### DESCRIPTION OF EMBODIMENTS

Hereinafter, embodiments of the present disclosure will be described with reference to the drawings. The following embodiments are examples for explaining the present disclosure, and technical content of the description in the claims is not limited to the following description.

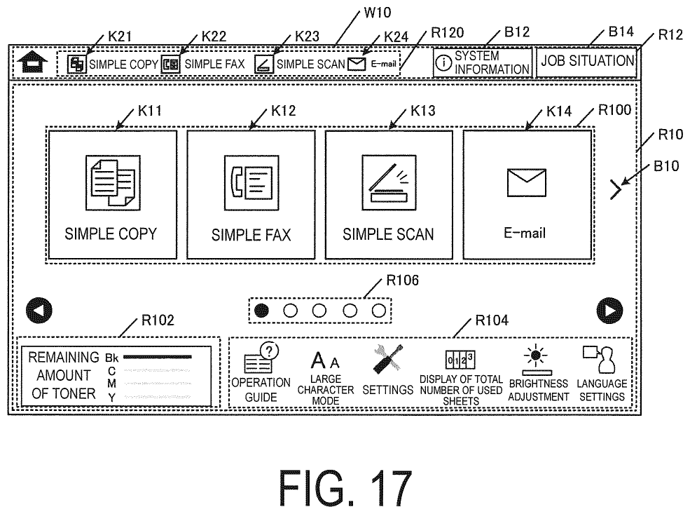

First, a screen configuration of a home screen according to the present disclosure will be described with reference to FIG. 17. FIG. 17 illustrates an example of a configuration of a home screen W10. The home screen W10 illustrated in FIG. 17 includes a variable region R10 serving as a first display region and a fixed region R12 serving as a second display region.

The variable region R10 can be configured as, for example, a rectangular display region having a display area of at least ¾ or more of a total display area that can be displayed on the home screen W10. The variable region R10 is a display region capable of displaying display content (operation content of each function) corresponding to each function assigned to an operation key through selection of the operation key, which will be described later, and is a display region capable of displaying a combination of operation keys different from a combination of currently displayed operation keys, based on an instruction to select a display switching button of the operation key. In the present disclosure, an aspect in which a display screen (content thereof) is switched based on a user operation or the like is called a screen transition.

The variable region R10 according to the present disclosure includes an operation key display region R100, an information display region R102, a setting display region R104, an indicator display region R106, and an operation key display switching button B10.

The operation key display region R100 is a display region that displays an operation key (shortcut key) that receives an instruction to switch to an operation mode corresponding to each function that can be realized by the image processing apparatus. FIG. 17 illustrates an example in which an operation key K11 assigned to a simple copy function, an operation key K12 assigned to a simple fax function, an operation key K13 assigned to a simple scan function, and an operation key K14 assigned to an e-mail function are displayed as switchable functions in the operation key display region R100 so that the functions can be selected. The combination of the operation keys K11, K12, K13, and K14 displayed in the operation key display region R100 can be switched to a different combination of operation keys by receiving an instruction to select the operation key display switching button B10. Here, the “simple” of the simple copy function, the simple fax function, and the simple scan function refers to an operation mode for simplifying operability by intentionally placing restrictions on some functions that can be realized by a normal copy function, fax function, and scan function. For example, a user who is not familiar with operations via an operation screen related to the normal copy function can easily perform copy processing or the like by selecting the simple copy function.

The information display region R102 is a display region that displays various pieces of information corresponding to an operating state of the device, such as a remaining amount of consumables such as a remaining amount of toner or a remaining amount of paper, device setting content, and a communication situation. The setting display region R104 is a display region that displays each setting item related to confirming and changing settings of the image processing apparatus. FIG. 17 illustrates an example in which “operation guide”, “large character mode”, “setting”, “display of total number of used sheets”, “brightness adjustment”, “language setting”, and the like are provided as items that can be set in the setting display region R104. Instead of the information display region R102 and the setting display region R104 in the variable region R10, a display region of the operation key display region R100 can be expanded from one row and four columns illustrated in FIG. 17 to, for example, two rows and four columns to increase the number of selectable operation keys.

The indicator display region R106 is a display region that displays an indicator showing which page a currently displayed page corresponds to, when the display content displayed in the variable region R10 involves a screen transition across a plurality of pages (for example, when there are a plurality of combinations of operation keys displayed in the operation key display region R100).

Meanwhile, the fixed region R12 can be configured as a rectangular display region that occupies the display region other than the variable region R10 in the home screen W10. The fixed region R12 is a display region whose display content remains unchanged (which displays fixed display content that does not correspond to, for example, a user operation with respect to the variable region R10) before and after a screen transition of the variable region R10, even when the variable region R10 involves the screen transition (displays display content corresponding to, for example, a user operation with respect to the variable region R10). FIG. 17 illustrates an example of a configuration of the home screen W10 in which the fixed region R12 is provided above the variable region R10 in the figure, but the fixed region R12 may be provided below the variable region R10 in the figure or on the left or right side in the figure, and there is no restriction on a disposition position of the fixed region R12.

The fixed region R12 according to the present disclosure includes an operation key display region R120, a system information button B12, and a job situation button B14.

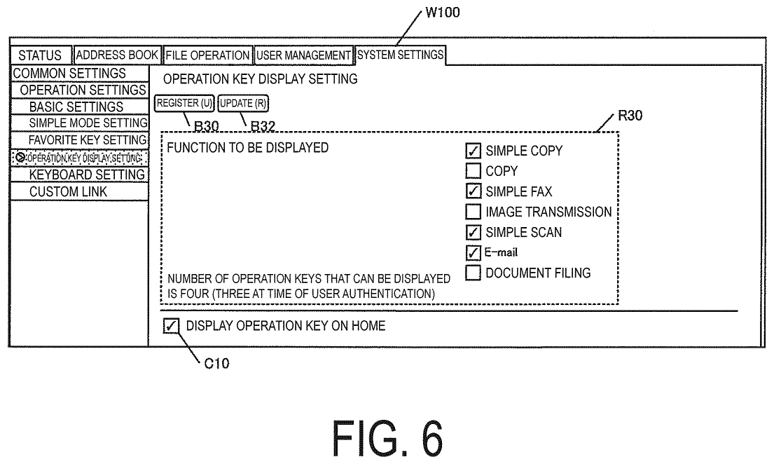

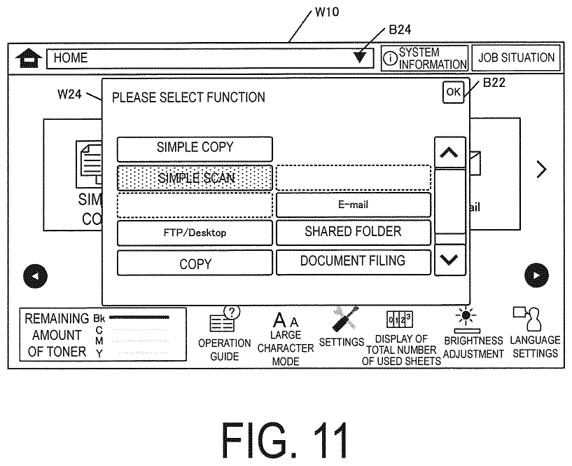

The operation key display region R120 is a display region that displays an operation key that receives the instruction to switch to the operation mode corresponding to each function that can be realized by the image processing apparatus, similar to the operation key display region R100 in the variable region R10. FIG. 17 illustrates an example in which an operation key K21 assigned to the simple copy function, an operation key K22 assigned to the simple fax function, an operation key K23 assigned to the simple scan function, and an operation key K24 assigned to the e-mail function are displayed as operation keys in the operation key display region R120. A form in which an operation key selection screen W24, which will be described later with reference to FIG. 11, can be displayed can also be used, in addition to the form in which the operation keys are displayed in the operation key display region R120. The form in which the operation key selection screen W24 can be displayed is effective when the display region is limited in the operation key display region R120 such that the operation keys cannot be displayed. Which form to use can be set, for example, in the operation key display setting screen W100 in FIG. 6, and which form to use can be determined based on the setting.

The system information button B12 is a button that receives an instruction to display system information of the image processing apparatus. When an instruction to select the system information button B12 is received from the user, the image processing apparatus displays a system information display screen (not illustrated). The job situation button B14 is a button that receives an instruction to display an execution situation (reserved job, job in progress, completed job, or the like) of a job received by the image processing apparatus. When an instruction to select the job situation button B14 is received from the user, the image processing apparatus displays a job situation display screen (not illustrated).

When an administrator wants to restrict the use of a specific function, the administrator can simply restrict (prohibit) user operations by performing control (screen edit) to hide the operation key (for example, any one of the operation keys K11, K12, K13, and K14) in the operation key display region R100 of the variable region R10.

However, the operation key display region R120 of the fixed region R12 is configured to be switched to an operation mode corresponding to each function even when display content in the variable region R10 becomes different display content depending on a screen transition. Therefore, since the same operation key as the operation key displayed in the operation key display region R100 of the variable region R10 can be displayed in the operation key display region R120 of the fixed region R12 and the operation key selection screen W24 of FIG. 11, it is not possible to restrict user operations by editing a screen of the variable region R10 alone.

On the other hand, when the administrator wants to restrict the use of a specific function, it is possible to restrict user operations for the function by using an authentication function, but since a setting is required for each user to be authenticated, there is a problem that setting work is complicated and troublesome.

In the present disclosure, an image processing apparatus capable of improving the operability of function selection for the user in an image processing apparatus that receives an instruction to select a function to be used, via an operation screen including a plurality of display regions is realized by the following embodiments.

### 1 First Embodiment

### 1.1 Functional Configuration

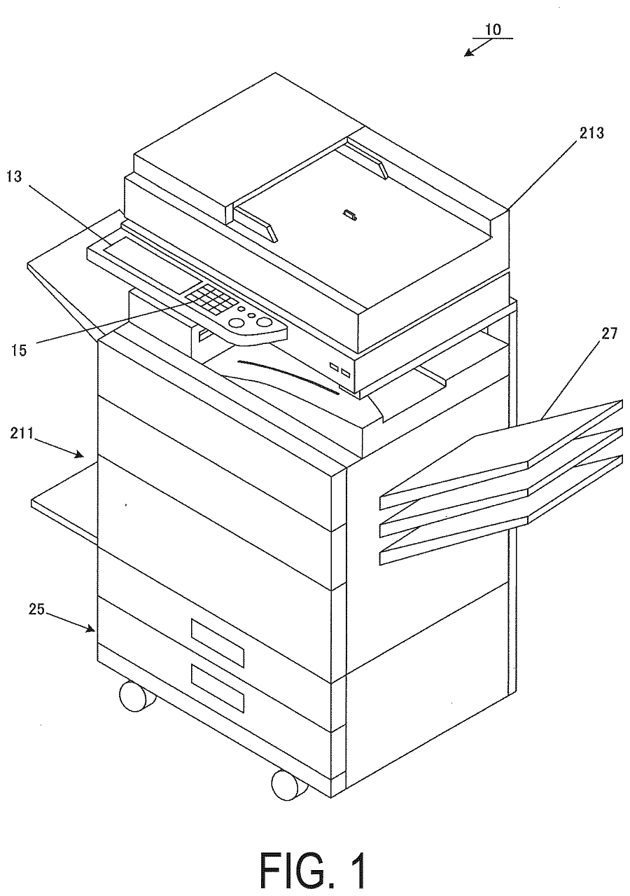

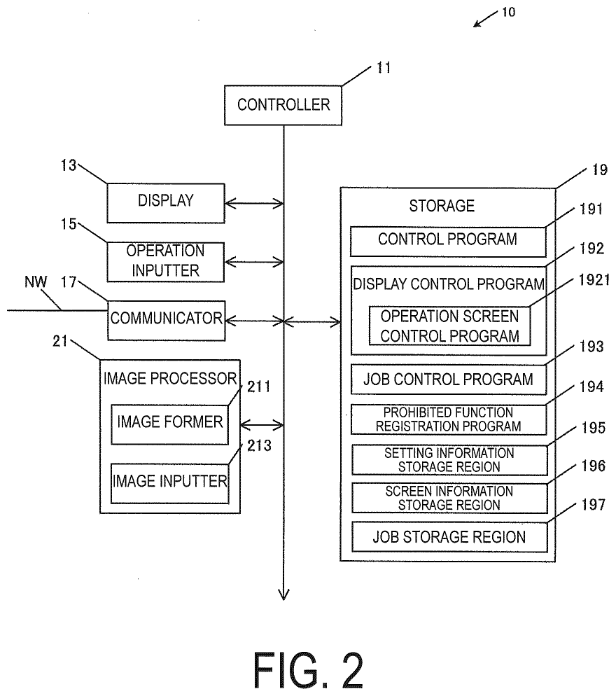

FIG. 1 is a diagram illustrating an overall configuration of a multifunction apparatus 10 as an image processing apparatus. FIG. 2 is a functional configuration diagram of the multifunction apparatus 10.

The multifunction apparatus 10 is an image processing apparatus capable of realizing a job related to each function, such as a copy (simple copy) function, a fax (simple fax) function, a scan (simple scan) function, and an e-mail function, in a single entity. In the present disclosure, an example of the multifunction apparatus will be described as one form of the image processing apparatus, but the image processing apparatus is not limited to the multifunction apparatus and may be, for example, a printer, copier, or fax machine like with each limited function.

Such a multifunction apparatus 10 includes a controller 11, a display 13, an operation inputter 15, a communicator 17, a storage 19, and an image processor 21.

The controller 11 generally controls the multifunction apparatus 10. The controller 11 can be configured of one or more computation devices (for example, a central processing unit (CPU) or a system on chip (SoC)). The controller 11 realizes its functions by reading and executing various programs stored in the storage 19.

The display 13 is a display device that displays various pieces of information to the user or the like. The display 13 can be configured of, for example, a liquid crystal display (LCD), an organic electro-luminescence (EL) display, or the like. The display 13 displays, for example, an operation screen such as a home screen or a setting screen related to an operation mode of each function.

The operation inputter 15 is an input device that receives information input by the user or the like. The operation inputter 15 can be configured of, for example, various input devices such as operation keys such as hardware keys and software keys, and buttons. The operation inputter 15 can be configured as a touch panel that can receive input via the display 13. When the operation inputter 15 is configured as the touch panel, the operation inputter 15 can detect a user's touch, tap, swipe, or the like with respect to an object displayed via the display 13, and can acquire a coordinate position, pressure-sensitive information, or the like of touch panel information. In this case, an input scheme for the touch panel can be a general input scheme such as a resistive film scheme, an infrared scheme, an electromagnetic induction scheme, or a capacitive scheme.

The communicator 17 includes a wired interface, a wireless interface, or a wired and wireless interface for communication with other devices via a network NW such as a local area network (LAN), a wide area network (WAN), the Internet, a telephone line, or a fax line. Further, the communicator 17 may also include an interface for short-range wireless communication technology such as Bluetooth (trade name), near field communication (NFC), Wi-Fi (trade name), ZigBee (trade name), infrared data association (IrDA), and wireless universal serial bus (USB).

The storage 19 is one or more storage devices that store various programs and various pieces of data required for operation of the multifunction apparatus 10. The storage 19 can be configured of a storage device such as a random access memory (RAM), a solid state drive (SSD), a hard disk drive (HDD), and a read only memory (ROM).

In the first embodiment, the storage 19 stores a control program 191, a display control program 192, a job control program 193, and a prohibited function registration program 194, and secures a setting information storage region 195, a screen information storage region 196, and a job storage region 197.

The control program 191 is a program that the controller 11 reads after the device starts. The controller 11 that reads the control program 191 functions as an operating system (OS) to control driving of hardware such as the display 13, the operation inputter 15, the communicator 17, and the image processor 21.

The display control program 192 is a program that the controller 11 reads when controlling an output of the operation screen displayed on the display 13 or the operation inputter 15 configured as a touch panel. The display control program 192 includes an operation screen control program 1921. The controller 11 that reads the operation screen control program 1921 receives, from the user, an instruction to edit a display configuration of the home screen W10 illustrated in FIG. 17 or the setting screen in each operation mode. The controller 11 determines the display configuration of the operation screen such as the home screen W10 based on the instruction received from the user, and displays the operation screen on the display 13 (the operation inputter 15).

The job control program 193 is a program that the controller 11 reads when executing a print job related to printing, copying or the like, or an image transmission job such as faxing or e-mailing. The controller 11 that reads the job control program 193 transitions to an operation mode based on each function for executing each job (for example, a simple copy mode, a simple fax mode, a simple scan mode, or an e-mail mode), and executes the job. When the controller 11 executes the job, the controller 11 can display, as an operation screen, a setting screen in each operation mode that receives a selection of a setting value or function required for execution of the job from the user on the touch panel, as necessary. The controller 11 can execute a job based on the setting values or functions received via the setting screen.

The prohibited function registration program 194 is a program that the controller 11 reads when receiving an instruction to select a function of which the use is prohibited from the user such as an administrator via a prohibited function selection screen that will be described later. The controller 11 that reads the prohibited function registration program 194 functions as a register to disable use of a function set (selected) as a prohibited function (a registration-prohibited function) and to control a display of, for example, an operation key assigned to the function on an operation screen such as the home screen W10 or an operation key assigned to a function not set as a registration-prohibited function (non-registration-prohibited function).

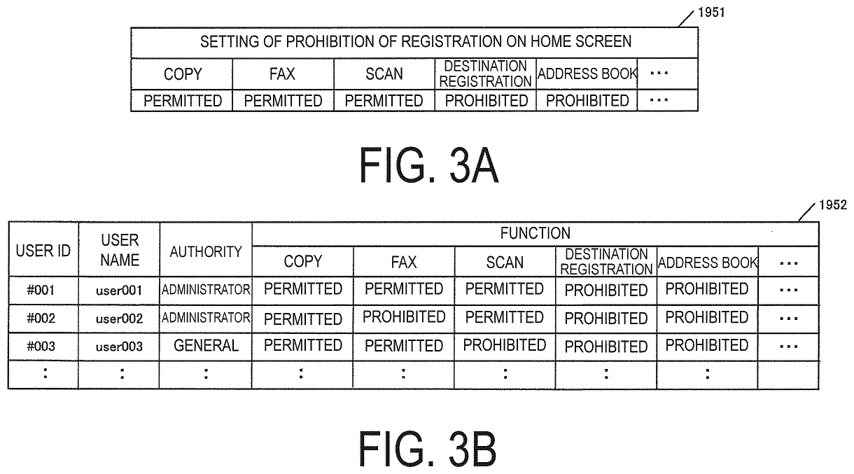

The setting information storage region 195 is a storage region that stores functions registered as registration-prohibited functions, setting values received via a setting screen related to each operation mode, selection information, and the like. Here, an example of a data configuration of a registration prohibition setting table stored in the setting information storage region 195 will be described with reference to FIG. 3A.

A registration prohibition setting table 1951 illustrated in FIG. 3A is a table for managing, in a table format, functions permitted to be registered on the home screen W10 and functions of which the registration is prohibited. FIGS. 3A and 3B illustrate an example in which functions related to “copy”, “fax” and “scan” are “permitted” to be registered on the home screen, while functions related to “destination registration” and “address book” are “prohibited” from being registered on the home screen. The controller 11 can determine whether or not each function can be registered on the home screen W10 by referring to the registration prohibition setting table 1951 as settings of a device body.

Even when user authentication is valid, it is possible to set whether or not to reflect the settings of the device body, and when the setting to reflect the settings of the device body is valid, it is also possible to manage whether or not each function can be registered on the home screen W10 by using a registration prohibition setting table 1952 illustrated in FIG. 3B. In this case, even when the user authentication is valid, a registration prohibition setting of the device body is reflected in whether or not registration of each function in each user is possible, and thus, it is possible to perform setting related to prohibition of registration of functions on the home screen for all users at once without changing the setting for each user.

Referring back to FIG. 2, the screen information storage region 196 is a storage region that stores necessary display content such as operation keys required to display operation screens such as the home screen W10 and the setting screen in each operation mode.

The job storage region 197 is a storage region that stores various jobs such as a print job and an image transmission job.

The image processor 21 includes an image former 211 and an image inputter 213. The image former 211 receives paper as a sheet-like medium fed from a paper feeder 25, forms an image on the paper based on image data, and then discharges the paper to a paper discharger 27. The image former 211 can be configured of, for example, a laser printer that employs an electrophotographic scheme.

The image inputter 213 generates image information by scanning a document. The image inputter 213 can be configured as a scanner device including an automatic document feeder (ADF), a flatbed for placing and reading a document, and the like, in addition to an image sensor such as a charge coupled device (CCD) or a contact image sensor (CIS). There is no particular limitation on a configuration of the image inputter 213, as long as the image inputter 213 can generate image information by reading a reflected light image from a document image with an image sensor. The image inputter 213 can also be configured as an interface capable of acquiring image information stored in a storage medium such as a USB memory, or image information transmitted from a device (such as an information processing apparatus; not illustrated). The image processor 21 may perform, for example, shading correction or density correction on the image information input from the image inputter 213 to generate image information for image transmission.

### 1.2 Processing Flow

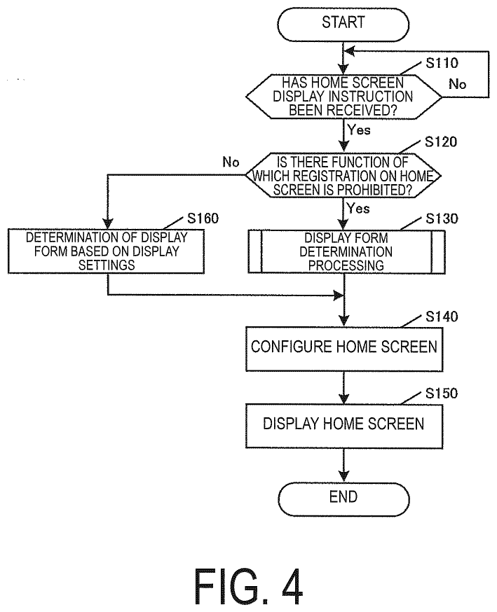

Next, a processing flow according to the first embodiment will be described. FIG. 4 is a flowchart illustrating a processing flow from when the instruction to display the home screen W10 is received to when the home screen W10 is displayed. The processing described in FIG. 4 is executed by the controller 11 reading the control program 191, the display control program 192 (operation screen control program 1921), the prohibited function registration program 194, and the like.

The controller 11 determines whether or not the instruction to display the home screen W10 has been received at an appropriate timing, such as at the time of power-on, standby, or recovery from a sleep state (step S110).

When the controller 11 determines that the instruction to display the home screen W10 has been received, the controller 11 determines whether or not there is a function of which the registration on the home screen W10 (the variable region R10 serving as the first display region) is prohibited (step S110; Yes→step S120). When the controller 11 determines that the instruction to display the home screen W10 has not been received, the controller 11 waits until the instruction to display is received (step S110; No).

When it is determined that a registration-prohibited function exists in the home screen W10, the controller 11 performs a process of determining a display form of the operation key assigned to the registration-prohibited function, of which the display on the home screen W10 is restricted (step S130). The process of determining the display form of the operation key in step S130 will be described in the next figure.

Next, the controller 11 configures the home screen W10 based on the display form of the operation key determined in step S130 (step S140), displays the home screen W10 on the display 13 (the operation inputter 15), and ends the processing (step S150).

When it is determined in step S120 that there is no function of which the registration on the home screen W10 (the variable region R10 serving as the first display region) is prohibited, the controller 11 determines a function (operation key) to be displayed on the home screen W10 based on a display settings previously set on a system setting screen (not illustrated) or the like, and proceeds to a process of step S140 (step S120; No→step S160 step S140).

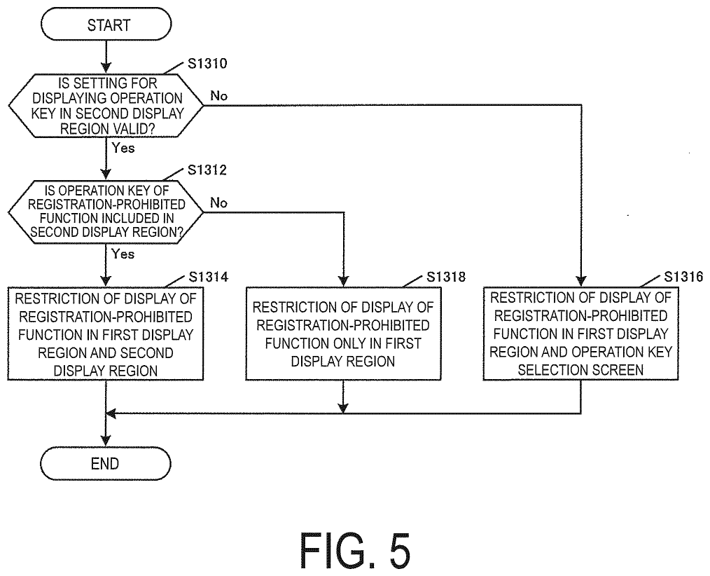

Next, the display form determination process related to step S130 in FIG. 4 will be described using the flowchart in FIG. 5. As described above, a process described in FIG. 5 is a process of determining the display form of the operation key (shortcut key) assigned to a registration-prohibited function, of which the display on the home screen W10 is restricted. Based on the process described in FIG. 5, the controller 11 controls the display of the operation key in the variable region R10 serving as the first display region, the fixed region R12 serving as the second display region, and the operation key selection screen W24 illustrated in FIG. 11.

When the display form determination process related in step S130 in FIG. 4 starts, the controller 11 determines whether or not a setting for displaying operation keys in the second display region of the home screen W10 is valid (step S1310). The setting for displaying the operation keys in the second display region will be described later.

When it is determined that the setting for displaying the operation keys in the second display region is valid, the controller 11 determines whether or not operation keys displayed in the second display region include the operation key related to the registration-prohibited function (step S1310; Yes→step S1312). It is possible to determine whether or not the operation keys displayed in the second display region include the operation key related to the registration-prohibited function, by referring to the registration prohibition setting table 1951 illustrated in FIG. 3A.

When it is determined that the operation keys displayed in the second display region include an operation key related to the registration-prohibited function, the controller 11 restricts the display of the operation key related to the registration-prohibited function in the first display region and the second display region, and ends the processing (step S1312; Yes→step S1314).

On the other hand, when it is determined that the setting for displaying the operation keys in the second display region is not valid, the controller 11 restricts the display of the operation key related to the registration-prohibited function in the first display region and the operation key selection screen, and ends the processing (step S1310; No→step S1316). Also, when it is determined that the operation keys to be displayed in the second display region do not include the operation key related to the registration-prohibited function, the controller 11 restricts the display of the operation key related to the registration-prohibited function only in the first display region, and ends the processing (step S1412; No→step S1418).

### 1.3 Operation Example

Next, an operation example according to the first embodiment will be described. FIG. 6 is a diagram illustrating an example of a configuration of the operation key display setting screen W100. The operation key display setting screen W100 is a setting screen that receives a setting related to the display of the operation key in the fixed region R12 (the operation key display region R120) as the second display region of the home screen W10. The operation example in FIG. 6 is an operation example corresponding to the process in, for example, steps S1310 to S1312 in FIG. 5.

The operation key display setting screen W100 includes a registration (U) button B30, an update (R) button B32, a function selection region R30, and an operation key display check box C10. The registration (U) button B30 is a button that receives an instruction to register settings received via the operation key display setting screen W100. The update (R) button B32 is a button that receives an instruction to update some (or all) of the settings received via the operation key display setting screen W100.

The function selection region R30 is a region that receives a selection of a function (corresponding to an operation key) to be displayed as an operation key in the fixed region R12 (the operation key display region R120). FIG. 6 illustrates a state in which four functions (operation keys) including “simple copy,” “simple fax,” “simple scan,” and “E-mail” have been selected as functions to be displayed as operation keys.

The operation key display check box C10 is a check box that receives a selection of whether or not to display an operation key related to a function selected by the user in the function selection region R30 on the home screen W10 (the operation key display region R120).

When the user checks the operation key display check box C10, the controller 11 displays, in the operation key display region R120 of the home screen W10, an operation key corresponding to the function selected by the user in the function selection region R30. When the user selects any operation key, the controller 11 calls and displays an operation screen for the function corresponding to the operation key.

On the other hand, when the operation key display check box C10 is not checked, it is possible to display the operation key selection screen W24 by selecting an arrow button B24 (see FIG. 11) provided in the operation key display region R120 of the home screen W10.

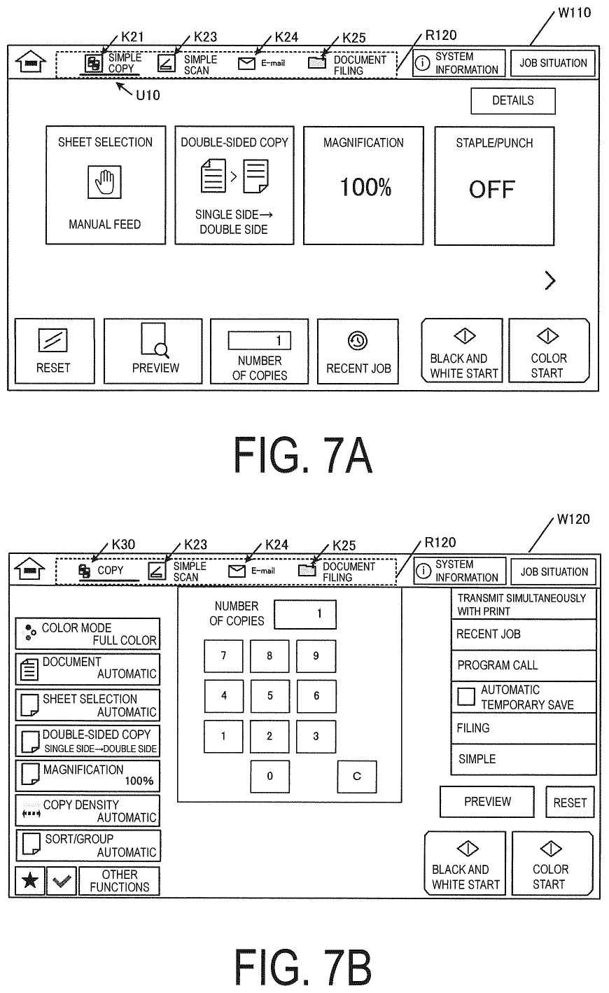

For example, in the operation screen for each function, such as a simple copy operation screen W110 illustrated in FIG. 7A, the operation key corresponding to the function selected by the user in the function selection region R30 is displayed in the operation key display region R120, regardless of whether or not the operation key display check box C10 is checked. Since the operation key related to the selected function is displayed with an identifier (for example, an underscore U10) so that the operation key can be distinguished from other operation keys, the user can easily ascertain that the operation screen related to the function is being displayed. For example, when the user selects an operation key K30 related to the selected function (copy function) on the operation screen related to the selected function (copy function) such as the copy operation screen W120 illustrated in FIG. 7B, the controller 11 displays the operation key selection screen W24. When the user selects an operation key other than the selected function (for example, the operation key K23 assigned to the simple scan function on the simple copy operation screen W110 or the copy operation screen W120) on the operation screen related to the selected function, the controller 11 displays an operation screen (not illustrated) related to the function (simple scan) assigned to the selected operation key.

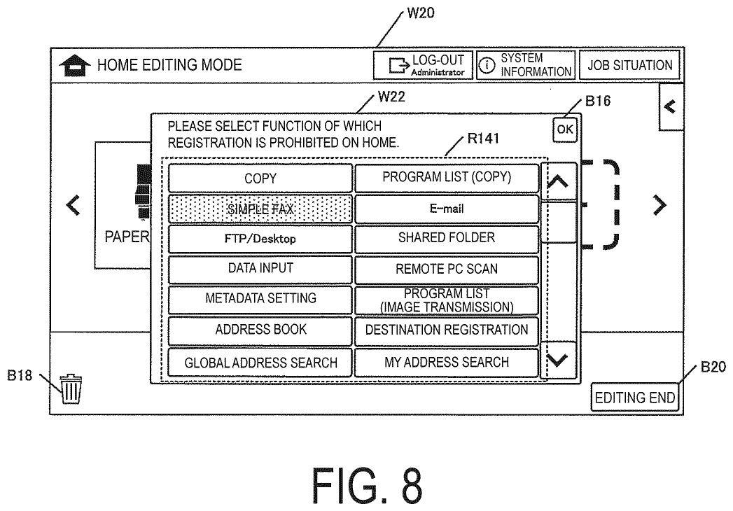

FIG. 8 is a diagram illustrating an example of a configuration of an editing screen W20 that receives an instruction to edit the variable region R10 (the operation key display region R100) serving as the first display region on the home screen W10 from the user. The editing screen W20 includes a prohibited function selection screen W22 that receives an instruction to select the registration-prohibited function in the first display region of the home screen W10, a trash button B18, and an editing end button B20.

The prohibited function selection screen W22 is a screen that receives an instruction to select the registration-prohibited function from the user. FIG. 8 illustrates a state in which a copy function, a simple fax function, an FTP/Desktop function, a data input function, a metadata setting function, an address book function, a global address search function, a program list (copy) function, an e-mail function, a shared folder function, a remote PC scan function, a program list (image transmission) function, a destination registration function, and my address search function are displayed as functions that can be selected as the registration-prohibited functions on the prohibited function selection screen W22, and the simple fax function has been selected as the registration-prohibited function by the user. The functions that can be selected as the registration-prohibited functions illustrated in FIG. 8 are merely examples, and the functions that can be selected as the registration-prohibited functions in the present disclosure are not limited to those described in FIG. 8. The function that can be selected as the registration-prohibited function can be configured as, for example, a toggle button, and selection/non-selection of the registration-prohibited function can be switched by selecting the toggle button, but the present disclosure is not limited thereto.

An OK button B16 provided on the prohibited function selection screen W22 is a button that receives a confirmation instruction for the selection of the function as the registration-prohibited function on the prohibited function selection screen W22. When an instruction to select the OK button B16 is received, the controller 11 registers the selected function as a registration-prohibited function in the registration prohibition setting table 1951 of the setting information storage region 195.

The trash button B18 is a button that receives an instruction to delete an item selected by the user on the editing screen W20 including the prohibited function selection screen W22. For example, a function to be unregistered is selected on a registration function selection screen (not illustrated), and then the trash button B18 is operated so that the selected function can be set as a non-registration function. The editing end button B20 is a button that receives an instruction to end the editing operation from the user via the editing screen W20.

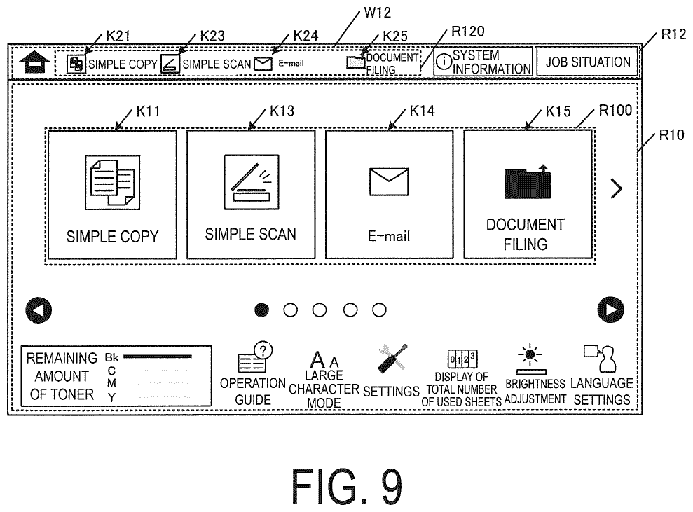

FIG. 9 illustrates an example of a configuration of a home screen W12 displayed by the controller 11 when the simple fax function is selected as a registration-prohibited function via the prohibited function selection screen W22 of the editing screen W20 illustrated in FIG. 8. FIG. 9 illustrates an operation example corresponding to a flow of a process related to step S1312; Yes→step S1314 in FIG. 5 and step S140→step S150 in FIG. 4.

As illustrated in FIG. 9, the home screen W12 shows a state in which a display of an operation key related to the simple fax function selected as a registration-prohibited function is restricted in the variable region R10 (the operation key display region R100) serving as the first display region in the home screen W10 illustrated in FIG. 17. As illustrated in FIG. 9, in the operation key display region R100 of the variable region R10 serving as the first display region, a display of the operation key K12 related to the simple fax function is restricted and an operation key K15 assigned to the document filing function serving as the non-registration-prohibited function is displayed. Further, in the operation key display region R120 of the fixed region R12 serving as the second display region, a display of the operation key K22 related to the simple fax function is restricted, and the operation key K25 assigned to the document filing function serving as the non-registration-prohibited function is displayed. The operation key displayed by restricting the display of the operation key K12 and the operation key K22 in the operation key display region R100 and the operation key display region R120 is not limited to the operation key K15 (K25) as long as the operation key is an operation key assigned to any non-registration-prohibited function.

According to the operation example of FIG. 9, since a setting of the registration-prohibited function in the variable region serving as the first display region of the home screen is also reflected in the display of the operation key in the fixed region serving as the second display region of the home screen, it is possible to easily restrict the use of the registration-prohibited function without performing a troublesome setting. Further, since the operation key related to the registration-prohibited function is not displayed, a message display for the operation key that cannot be used becomes unnecessary. Further, it is possible to reduce unnecessary operations such as message confirmation for the user.

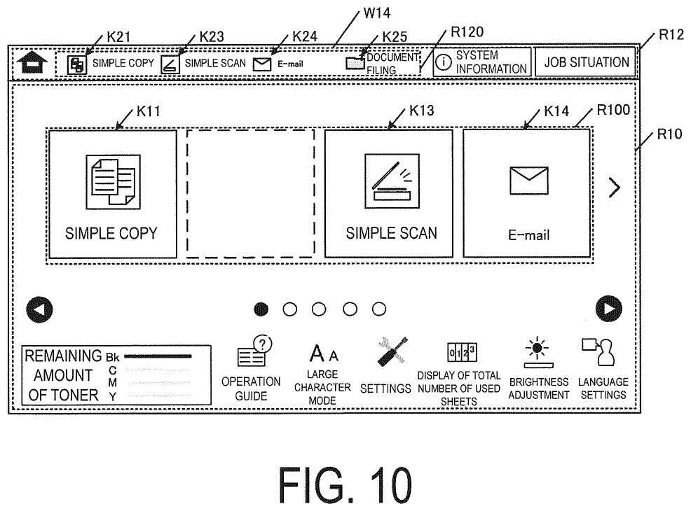

FIG. 10 illustrates an example of a configuration of a home screen W14 displayed by the controller 11 when the simple fax function is selected as a registration-prohibited function via the prohibited function selection screen W22 of the editing screen W20 illustrated in FIG. 8. FIG. 10 illustrates an operation example corresponding to a flow of a process related to step S1312; No→step S1318 in FIG. 5 and step S140→step S150 in FIG. 4.

As illustrated in FIG. 10, the home screen W14 shows a state in which only the display of the operation key K12 related to the simple fax function selected as the registration-prohibited function is restricted in the variable region R10 (the operation key display region R100) serving as the first display region in the home screen W10 illustrated in FIG. 17. In FIG. 10, the display of the operation key K12 related to the simple fax function is restricted in the operation key display region R100 of the variable region R10 serving as the first display region, but no operation key is displayed (blank) at a display position where the operation key K12 has been displayed before the simple fax function is selected as the registration-prohibited function, unlike the example in FIG. 9. Therefore, control is not performed such that the operation key K13 is displayed at the display position where the operation key K12 has been displayed, the operation key K14 is displayed at a display position where the operation key K13 has been displayed, and the operation key K15 assigned to the document filing function serving as the non-registration-prohibited function is displayed at a display position where the operation key K14 has been displayed, as shown in the example of FIG. 9. On the other hand, in the operation key display region R120 of the fixed region R12 serving as the second display region, the display of the operation key K22 related to the simple fax function is restricted, the operation key K23 is displayed at a display position where the operation key K22 has been displayed, the operation key K24 is displayed at a display position where the operation key K23 has been displayed, and the operation key K25 assigned to the document filing function serving as the non-registration-prohibited function is displayed at a display position where the operation key K24 has been displayed. The operation key displayed at the display position where the operation key K24 has been displayed is not limited to the operation key K25 as long as the operation key is an operation key assigned to any non-registration-prohibited function.

According to the operation example of FIG. 10, since only restriction of the display of the operation key related to the registration-prohibited function is performed in the variable region, it is possible to prevent user's operability from being degraded, by changing the disposition of the operation keys in the operation key display region R100. Further, since the display of the operation key related to the registration-prohibited function is restricted in the fixed region, and the operation key related to the non-registration-prohibited function is newly displayed, it is possible to effectively utilize a display space of a limited fixed region in which the number of displayed operation keys is restricted.

FIG. 11 illustrates an example of a configuration of the operation key selection screen W24 as a selection screen displayed by the controller 11 when the simple fax function is selected as a registration-prohibited function via the prohibited function selection screen W22 of the editing screen W20 illustrated in FIG. 8. FIG. 11 illustrates an operation example corresponding to a flow of a process related to step S1310; No→step S1316 in FIG. 5 and step S140→step S150 in FIG. 4.

In the operation key selection screen W24 of FIG. 11, the display of the operation key related to, for example, the simple fax function selected as the registration-prohibited function from among the operation keys that can be displayed on the home screen W10 or the like is restricted (for example, a dotted frame in the figure).

The OK button B22 provided on the operation key selection screen W24 is a button that receives a confirmation instruction to confirm the transition to the operation screen for the function related to the operation key selected on the operation key selection screen W24. The arrow button B24 is a button that receives an instruction to display the operation key selection screen W24.

According to the operation example of FIG. 11, since a setting of the registration-prohibited function in the variable region serving as the first display region of the home screen is also reflected in the display of the operation key on the operation key selection screen, it is possible to easily restrict the use of the registration-prohibited function without performing a troublesome setting. Further, since the operation key related to the registration-prohibited function is not displayed, a message display for the operation key that cannot be used becomes unnecessary. Further, it is possible to reduce unnecessary operations such as message confirmation for the user.

As described above, according to the first embodiment, it is possible to provide, for example, an image processing apparatus capable of improving the operability of function selection for the user in an image processing apparatus that receives an instruction to select a function to be used, via an operation screen including a plurality of display regions.

### 2 Second Embodiment

A second embodiment is an embodiment in which a display of a function (operation keys) related to non-registration-prohibited function to be displayed in the second display region is determined based on a predetermined priority in the operation example illustrated in FIG. 10 of the first embodiment.

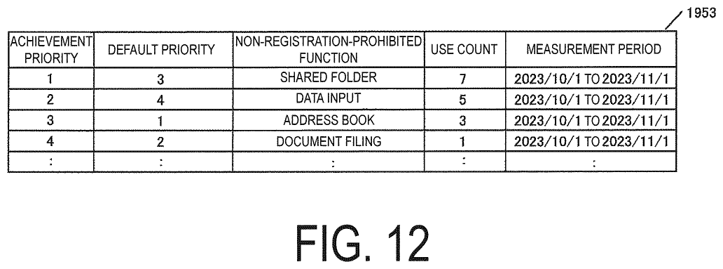

Since a functional configuration and processing flow of the multifunction apparatus according to the second embodiment can be the same as the functional configuration and processing flow of the multifunction apparatus 10 described in the first embodiment, detailed description thereof will be omitted here. A display order of functions (operation keys) to be displayed in the fixed region R12 serving as the second display region may be determined, for example, by the controller 11 reading the prohibited function registration program 194 referring to a use count management table 1953 illustrated in FIG. 12.

Here, an example of a data configuration of the use count management table 1953 according to the second embodiment will be described with reference to FIG. 12. The use count management table 1953 includes, as management items, an achievement priority, a default priority, a non-registration-prohibited function, a use count, and a measurement period.

The achievement priority is a display priority of the operation key related to the non-registration-prohibited function that is determined based on the use count of the non-registration-prohibited function in a predetermined period (measurement period). When the achievement priority is used as a parameter for determining the priority, the controller 11 determines, for example, the function related to the non-registration-prohibited function having the largest use count as a function (operation key) to be displayed in the fixed region R12 in order from top 1 (for example, achievement priority of first to fourth places).

The default priority is an initial value set for a display order (display priority) of the function (operation key) that is displayed in the fixed region R12, regardless of the use count in a predetermined period. The default priority can be set arbitrarily by the user with an administrator authority by considering parameters such as the purpose of use of the function related to the non-registration-prohibited function, a frequency of the use, the number of users who use the function, and a time period of the use. When the default priority is used as a parameter for determining the priority, the controller 11 determines, for example, functions related to the non-registration-prohibited function set as the default priority as functions (operation keys) that are displayed in the fixed region R12 in order from top 1 (for example achievement priority of first to fourth places).

The non-registration-prohibited function indicates a name of the non-registration-prohibited function that is a display target in the fixed region R12 according to any one of the achievement priority and the default priority. The use count indicates the number of times the non-registration-prohibited function has been used within the measurement period shown in the next section. The measurement period indicates a period during which the use count has been measured to determine the achievement priority.

For example, since a “shared folder” that is the non-registration-prohibited function is a function having a default priority set to a “third place”, but is the non-registration-prohibited function that has been used most frequently during a measurement period “2023 Oct. 1 to 2023 Nov. 1” (use count: “7”), a display order based on the achievement priority is set to a “first place”.

An example in which the use count of the non-registration-prohibited function in a predetermined period is one of the parameters related to the determination of the achievement priority has been described with reference to FIG. 12, but the achievement priority is not limited thereto and, for example, the achievement priority can be determined based on a ratio of the use count of a specific non-registration-prohibited function to the use count of all pre-set non-registration-prohibited functions. Further, information on the user who has used the non-registration-prohibited function may be taken into account for the determination of the achievement priority, and a form in which only the use count of the non-registration-prohibited function used by a specific user is counted as the use count related to the determination of the achievement priority can be used.

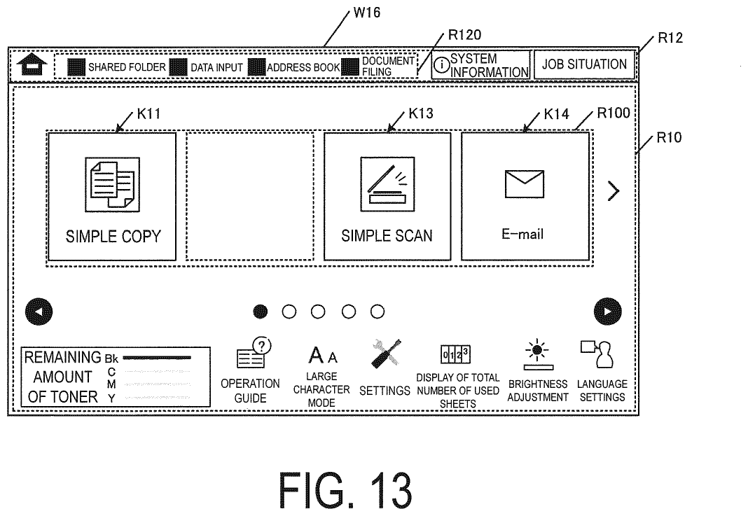

FIG. 13 illustrates an example of a configuration of a home screen W16 displayed by the controller 11 when the simple fax function is selected as a registration-prohibited function via the prohibited function selection screen W22 of the editing screen W20 illustrated in FIG. 8 in the second embodiment. FIG. 13 illustrates an operation example corresponding to the flow of a process related to step S1312; No→step S1318 in FIG. 5 and step S140→step S150 in FIG. 4, as in the example in FIG. 10.

As illustrated in FIG. 13, operation keys related to a shared folder function, a data input function, an address book function, and a document filing function are displayed as non-registration-prohibited functions in the operation key display region R120 of the fixed region R12 serving as the second display region, based on the achievement priority illustrated in FIG. 12.

As described above, according to the second embodiment, the display of the operation key related to the registration-prohibited function is restricted in the variable region serving as the first display region of the home screen, and the operation key related to the non-registration-prohibited function is displayed in the fixed region serving as the second display region of the home screen, based on a predetermined priority (achievement priority), making it possible to effectively utilize a display space of a limited fixed region in which the number of displayed non-registration-prohibited functions is limited, and to improve user convenience. Further, only restriction of the display of the operation key related to the registration-prohibited function is performed in the variable region serving as the first display region of the home screen, making it possible to prevent the user's operability from being degraded due to a change in disposition of the operation keys.

### 3. Third Embodiment

A third embodiment is an embodiment in which, when a setting screen related to an operation mode of each function is displayed, and when a function displayed in the variable region serving as the first display region is included in the fixed region serving as the second display region, a display of the function (operation key) in the fixed region is restricted.

### 3.1 Functional Configuration

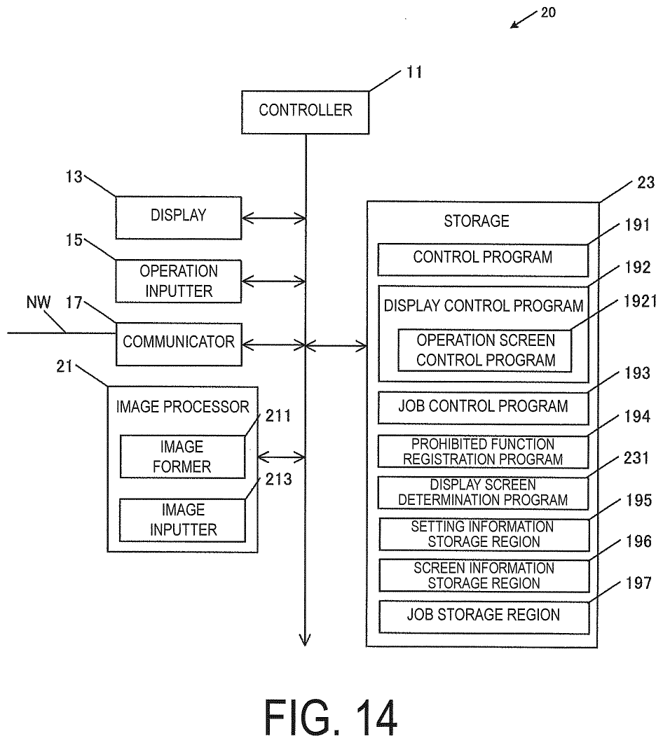

A functional configuration of the multifunction apparatus 20 according to the third embodiment will be described with reference to FIG. 14. Further, parts that can be configured in the same way as those in the multifunction apparatus 10 according to the first embodiment are denoted by the same reference signs, and description thereof will be omitted.

The multifunction apparatus 20 includes a storage 23 instead of the storage 19 of the multifunction apparatus 10 according to the first embodiment.

In the third embodiment, the storage 23 stores a control program 191, a display control program 192, a job control program 193, a prohibited function registration program 194, and a display screen determination program 231, and secures a setting information storage region 195, a screen information storage region 196, and a job storage region 197.

The display screen determination program 231 is a program that the controller 11 reads when displaying a setting screen related to the operation mode of each function. The controller 11 that reads the display screen determination program 231 determines whether or not a function (operation key) overlapping a function related to the variable region serving as the first display region in the setting screen to be displayed is included in the fixed region serving as the second display region.

### 3.2 Processing Flow

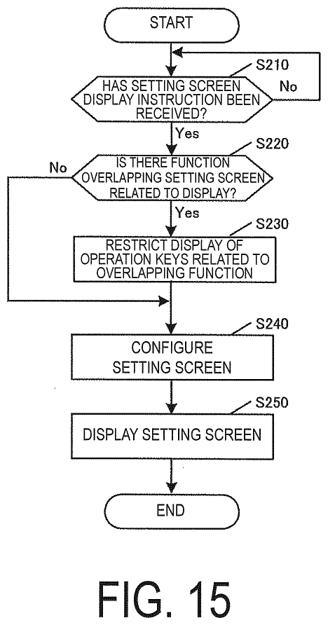

Next, a processing flow according to the third embodiment will be described with reference to the flowchart of FIG. 15. The processing described in FIG. 15 is executed by the controller 11 by reading the control program 191, the display control program 192 (operation screen control program 1921), the display screen determination program 231, and, as necessary, the prohibited function registration program 194.

First, the controller 11 determines whether or not an instruction to display a setting screen related to an operation mode corresponding to each function has been received (step S210). The instruction to display the setting screen can be determined, for example, depending on whether or not an instruction to select, for example, the operation keys (K11 to K14 and K21 to K24) displayed on the home screen W10 illustrated in FIG. 17 has been received.

When it is determined that the instruction to display the setting screen has been received, the controller 11 determines whether or not the function (operation key) overlapping the function to be displayed in the variable region serving as the first display region in the setting screen related to the display is included in the fixed region serving as the second display region (step S210; Yes→step S220). When it is determined that the instruction to display the setting screen has not been received, the controller 11 waits until the instruction to display is received (step S210; No).

When it is determined that the function (operation key) overlapping the function to be displayed in the variable region serving as the first display region in the setting screen related to the display is included in the fixed region, the controller 11 restricts the display of the function (operation key) in the fixed region (step S220; Yes→step S230).

Then, the controller 11 configures a setting screen to be displayed (step S240), displays the setting screen on the display 13 (the operation inputter 15), and ends the processing (step S250).

When it is determined in step S220 that the function (operation key) overlapping the function to be displayed in the variable region serving as the first display region in the setting screen related to the display is not included in the fixed region R12, the controller 11 omits a process related to step S230 and proceeds to a process of step S240 (step S220; No→step S240).

### 3.3 Operation Example

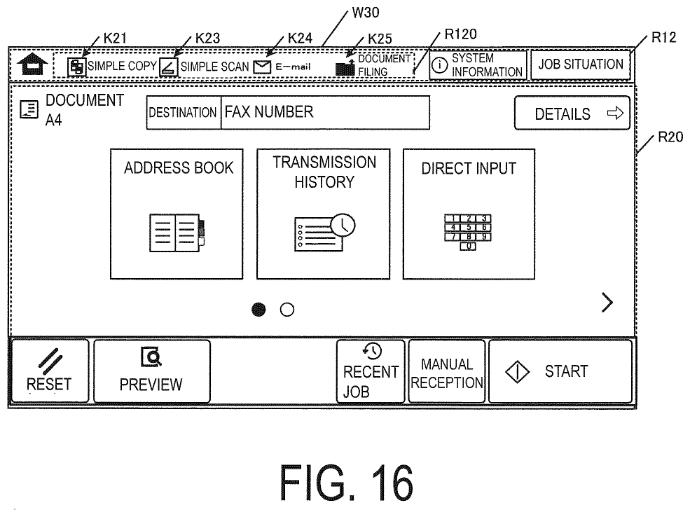

Next, an operation example according to the third embodiment will be described with reference to FIG. 16. FIG. 16 is a diagram illustrating an example of a configuration of a setting screen W30 related to simple fax that is displayed upon receiving an instruction to select operation keys (K12 and K22) related to “simple fax” on the home screen W10 illustrated in FIG. 17.

The setting screen W30 includes a variable region R20 as the first display region that receives input of a setting value such as a fax number, and a fixed region R12 (the operation key display region R120) as the second display region.

FIG. 16 illustrates an example in which a display of a function (operation key K22) related to the simple fax in the fixed region R12 (the operation key display region R120) is restricted in response to a display of the variable region R20 related to the simple fax, and the operation key K25 assigned to “document filing” as the non-registration-prohibited function is displayed.

As described above, according to the third embodiment, since the display of the function (operation key) that overlaps the function displayed in the variable region is restricted in the fixed region serving as the second display region, it is possible to effectively utilize a display space of a limited fixed region in which the number of displayed operation keys related to the non-registration-prohibited functions is restricted, and to improve the user's convenience.

The present disclosure is not limited to the above-described embodiments, and various modifications are possible. In other words, the technical scope of the present disclosure also includes embodiments obtained by combining technical means that are appropriately modified within the scope of the gist of the present disclosure.

Further, although the above-described embodiments are described separately for convenience of description, it is obvious that the embodiments may be executed in combination within a technically possible scope.

Further, in the embodiment, a program operating on each device is a program that controls a CPU or the like (a program for causing a computer to function) to realize the functions of the above-described embodiment. Information handled by such a device is temporarily stored in a temporary storage device (for example, a RAM) during processing and then stored in various storage devices such as read only memories (ROMs) and HDDs, and is read, modified, and written by the CPU as necessary.

Here, a computer-readable non-transitory recording medium on which the program is recorded in the information processing apparatus may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), Blu-ray (BD; trade name) disc), or the like), a magnetic recording medium (for example, a magnetic tape or flexible disk), and the like. In this case, the program recorded on the recording medium is read by the computer of the information processing apparatus and executed by the computer, so that not only the functions of the above-described embodiment are realized, but also functions of the present disclosure are realized by performing processing in cooperation with an operating system, another application program, or the like based on instructions of the program.

Further, when a program is distributed in the market, the program can be stored in a portable recording medium and distributed, or can be transferred to a server computer connected via a network such as the Internet. In this case, it is obvious that a storage device of the server computer is also included in the present disclosure.

Further, each functional block or feature of the device used in the above-described embodiment can be implemented and executed by an electric circuit, such as an integrated circuit or a plurality of integrated circuits. The electric circuit designed to realize the functions described herein may include a general-purpose processor, a digital signal processor (DSP), an application-specific integrated circuit (ASIC), a field programmable gate array (FPGA), another programmable logic device, a discrete gate or transistor logic, a discrete hardware component, or a combination thereof. The general-purpose processor may be a microprocessor or may be a processor, controller, microcontroller, or state machine of the related art. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the present disclosure.

### DESCRIPTION OF REFERENCE CHARACTERS

10, 20 Multifunction apparatus
11 Controller
13 Display
15 Operation inputter
17 Communicator
19, 23 Storage
191 Control program
192 Display control program
1921 Operation screen control program
193 Job control program
194 Prohibited function registration program
195 Setting information storage region
196 Screen information storage region
197 Job storage region
21 Image processor
211 Image former
213 Image inputter
231 Display screen determination program

1. An image processing apparatus comprising:
a display that displays, on an operation screen, operation keys associated with functions related to image processing and receiving an instruction to select a function to be used;
one or more controllers that control displaying the operation key on the operation screen; and
a register that registers the function with restriction on use,
wherein the operation screen includes a first display region capable of displaying the operation key and a second display region different from the first display region, and
the one or more controllers control displaying the operation key in the first display region and the second display region with respect to the function registered in the register.

2. The image processing apparatus according to claim 1, wherein the one or more controllers restrict the display of the operation key corresponding to the function registered in the register in the first display region and the second display region.

3. The image processing apparatus according to claim 1, wherein the one or more controllers restrict displaying the operation key corresponding to the function registered in the register in the first display region, restrict displaying the operation key corresponding to the function registered in the register in the second display region, and perform control to display the operation key corresponding to the function not registered in the register.

4. The image processing apparatus according to claim 1, wherein
the display is capable of displaying a selection screen for receiving an instruction to display the operation key, and
the one or more controllers restrict the display in the selection screen of the operation key corresponding to the function registered in the register.

5. The image processing apparatus according to claim 3, wherein the one or more controllers determine the operation key to be displayed in the second display region according to a display priority of the function.

6. An image processing apparatus comprising:
a display that displays, on an operation screen, operation keys associated with functions related to image processing and receiving an instruction to select a function to be used; and
one or more controllers that control displaying the operation key on the operation screen, wherein
the operation screen includes a first display region capable of displaying the operation key and a second display region different from the first display region, and
the one or more controllers restrict displaying the operation key corresponding to the function in the second display region when an operation screen based on a function corresponding to the operation key is displayed on the display, according to the instruction to select the operation key displayed on at least one of the first display region and the second display region.

7. The image processing apparatus according to claim 1, wherein
the first display region is a display region capable of displaying display content corresponding to the operation key related to the selection instruction, and
the second display region is a display region capable of displaying display content not corresponding to the operation key related to the selection instruction.

8. An operation key display method for displaying, on an operation screen, operation keys associated with functions related to image processing and receiving an instruction to select a function to be used, wherein
the operation screen includes a first display region capable of displaying the operation key and a second display region different from the first display region, and
the operation key display method comprises
registering the function with restriction on use; and
controlling displaying the operation key in the first display region and the second display region with respect to the registered function.
